(19) United States
(12) Patent Application Publication
(10) Pub. No.: US 2025/0252568 A1
(43) Pub. Date: Aug. 7, 2025

(54) SYSTEMS AND METHODS FOR IMAGE SEGMENTATION OF PET/CT USING CASCADED AND ENSEMBLED CONVOLUTIONAL NEURAL NETWORKS

(71) Applicant: Subtle Medical, Inc., Menlo Park, CA (US)

(72) Inventors: Lei XIANG, Shanghai (CN); Ludovic SIBILLE, Rosny-sur-Seine (FR); Xinrui ZHAN, Shanghai (CN)

(21) Appl. No.: 19/063,668

(22) Filed: Feb. 26, 2025

Related U.S. Application Data
(63) Continuation of application No. PCT/CN2023/113700, filed on Aug. 18, 2023.

(30) Foreign Application Priority Data
Aug. 30, 2022 (WO) PCT/CN2022/115744

(51) Int. Cl. G06T 7/00; G06T 3/40; G06T 7/11; G06T 7/174

(52) U.S. Cl. CPC G06T 7/0012; G06T 3/40; G06T 7/11; G06T 7/174; G06T 2200/24; G06T 2207/10081; G06T 2207/10104; G06T 2207/20016; G06T 2207/20081; G06T 2207/20084; G06T 2207/30096

(57) ABSTRACT

A computer-implemented method is provided for segmentation of Positron emission tomography (PET)/computed tomography (CT). The method comprises: acquiring an original medical image including a PET image and CT image of a subject; transforming the original medical image into an input image with a predetermined resolution and a plurality of channels; processing the input image using an ensembled CNNs to output an intermediate segmentation mask; and taking the intermediate segmentation mask as input to a refiner model to output a final segmentation mask, where the final segmentation mask has a resolution same as the resolution of the original medical image.

### CROSS-REFERENCE TO RELATED APPLICATION

This application is a continuation of PCT International Application No. PCT/CN2023/113700 filed on Aug. 18, 2023, which claims priority to PCT International Application No. PCT/CN2022/115744 filed on Aug. 30, 2022, the content of which is incorporated herein in its entirety.

### BACKGROUND

Positron emission tomography (PET) with fluorine 18 (18F) fluorodeoxyglucose (FDG) has a substantial impact on the diagnosis and clinical decisions of oncological diseases. 18F-FDG uptake (refers to the amount of radiotracer uptake) highlights regions of high glucose metabolism that include both pathological and physiological processes. Positron emission tomography with 2-deoxy-2-[fluorine-18] fluoro-D-glucose integrated with computed tomography (18F-FDG PET/CT) has emerged as a powerful imaging tool for the detection of various cancers. The combined acquisition of PET and computed tomography (CT) has synergistic advantages over PET or CT alone and minimizes their individual limitations. For example, ¹⁸F-FDG PET/CT has been utilized in the initial diagnosis, detection of recurrent tumor, and evaluation of response to therapy in lung cancer, lymphoma and melanoma.

¹⁸F-FDG PET images are interpreted by experienced nuclear medicine readers that identify foci positive for 18F-FDG uptake that are suspicious for tumor. This classification of ¹⁸F-FDG positive foci is based on a qualitative analysis of the images and it is particularly challenging for malignant tumors with a low avidity, unusual tumor sites, with motion or attenuation artifacts, and the wide range of ¹⁸F-FDG uptake related to inflammation, infection, or physiologic glucose consumption. A crucial initial processing step for quantitative PET/CT analysis is segmentation of tumor lesions enabling accurate feature extraction, tumor characterization, oncologic staging and image-based therapy response assessment. Currently, the lesion segmentation is conducted manually or computer-assisted which is usually labor-intensive and costly, and may suffer from high inter-reader variability, thus is infeasible in clinical routine.

### SUMMARY

A need exists for automated lesion segmentation for PET/CT images. The present disclosure provides deep neural network that is developed to segment regions suspected for cancer with improved accuracy. In particular, methods and systems herein may be able to segment lesion regions in whole-body ¹⁸F-FDG PET/CT images and can address various drawbacks of conventional systems, including those recognized above.

In an aspect, a computer-implemented method is provided for segmentation of Positron emission tomography (PET)/computed tomography (CT). The method comprises: acquiring an original medical image including a PET image and CT image of a subject; transforming the original medical image into an input image with a predetermined resolution and a plurality of channels, where the plurality of channels correspond to a plurality of intensity ranges; processing the input image using an ensembled CNNs to output an intermediate segmentation mask; and taking the intermediate segmentation mask as input to a refiner model to output a final segmentation mask, where the final segmentation mask has a resolution same as the resolution of the original medical image.

In a related yet separate aspect, the present disclosure provides a non-transitory computer-readable storage medium including instructions that, when executed by one or more processors, cause the one or more processors to perform operations. The operations comprise: acquiring an original medical image including a PET image and CT image of a subject; transforming the original medical image into an input image with a predetermined resolution and a plurality of channels, where the plurality of channels correspond to a plurality of intensity ranges; processing the input image using an ensembled CNNs to output an intermediate segmentation mask; and taking the intermediate segmentation mask as input to a refiner model to output a final segmentation mask, where the final segmentation mask has a resolution same as the resolution of the original medical image.

In some embodiments, the predetermined resolution is lower than the resolution of the original medical image. In some embodiments, the intermediate segmentation mask has a resolution same as the predetermine resolution.

In some embodiments, the plurality of channels are determined automatically by processing the original medical image. In some embodiments, the plurality of channels are determined manually by a user. In some embodiments, the ensembled CNNs comprise a plurality of 3D U-net like CNNs. In some cases, a plurality of outputs of the 3D U-net like CNNs are linearly weighted to generate the intermediate segmentation mask.

In some embodiments, the input to the refiner model further comprises at least a portion of the original medial image. In some embodiments, the ensembled CNNs and the refiner model are trained separately using a loss function. In some cases, the loss function comprises a combination of dice loss and a cross-entropy loss to stabilize the training. In some instances, the loss function further comprises a sensitivity loss.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and descriptions are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows an example of the cascaded model network, in accordance with some embodiments of the present disclosure.

FIG. 2 shows examples of various FDG uptakes in different tissues across different patients.

FIG. 3 shows exemplary result of segmentations of lesions.

FIG. 4 shows an example of a system implementing the methods described herein.

FIG. 5 shows examples of segmentation of lesion generated by the system herein (FOUND) compared to the ground truth result (TRUTH).

### DETAILED DESCRIPTION OF THE INVENTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

### Methods and Deep Learning Framework

The present disclosure provides a deep neural network that is developed to segment regions suspected for cancer with improved accuracy. In particular, methods and systems herein may be able to segment lesion regions in whole-body ¹⁸F-FDG PET/CT images with improved accuracy and efficiency. In an aspect of the present disclosure, a cascaded approach is provided for segmentation of Positron emission tomography (PET)/computed tomography (CT). The method comprises: acquiring an original medical image including a PET image and CT image of a subject; transforming the original medical image into an input image with a predetermined resolution and a plurality of channels; processing the input image using an ensembled CNNs to output an intermediate segmentation mask; and taking the intermediate segmentation mask as input to a refiner model to output a final segmentation mask, where the final segmentation mask has a resolution same as the resolution of the original medical image.

In some embodiments, the cascaded approach may comprise a first module (course level processing) and a second module (refiner network). In some embodiments, the first module may have a large field of view to analyze at a coarse level global patterns and long-range dependencies. The second module may be trained to refine the coarse segmentation found by the first module and the refinement may use the original image.

The original input images may be pre-processed such that the image to be analyzed by the first modules is fixed in resolution. For instance, the original input images may be downsampled to a predetermined resolution (e.g., 6 mm/pixel) prior to being processed by the first module. This beneficially allows the system or the first module to be resolution independent.

In some embodiments, the first module comprises a stacked ensemble of UNet convolutional neural network (CNN) to process the PET/CT images at a predetermined resolution (e.g., 6 mm per pixel resolution). In some cases, the ensembled UNet may be three-dimensional (3D) UNet. In some embodiments, the second module comprises a refiner network composed of residual layers to recover the original resolution. The second module may take at least part of the original image as the input and process the at least portion of the original image along with the output of the first module to recover the original resolution and refine the segmentation result.

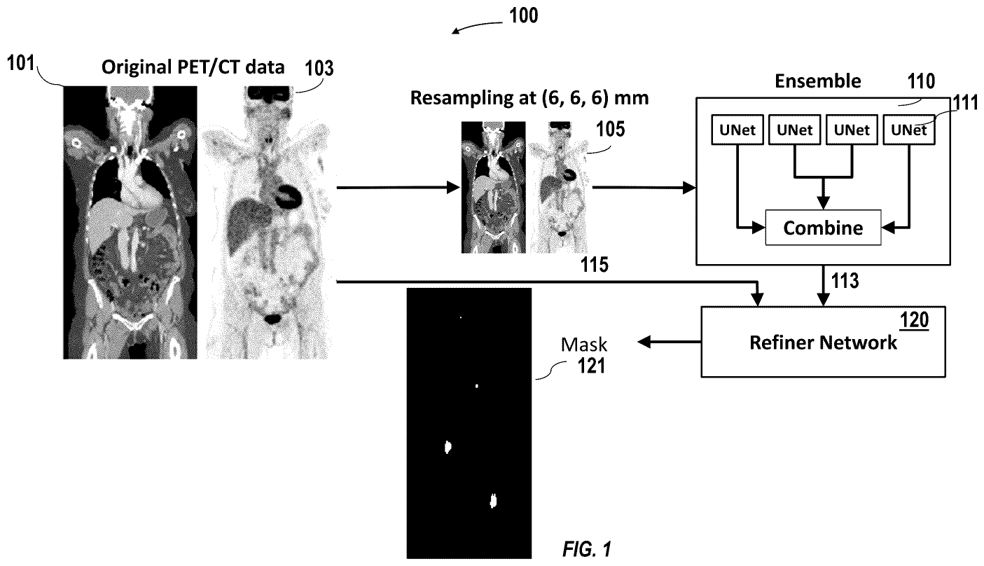

FIG. 1 shows an example of a cascaded model network 100, in accordance with some embodiments of the present disclosure. In some embodiments, the input images may comprise an original PET 103 data and original CT data 101. The input PET 103 and CT data 101 may be acquired in the same imaging session or ¹⁸F-FDG PET/CT acquisition. The input image data may have an original resolution. The original resolution may be dependent on the imaging system i.e., PET/CT imaging system. For example, the original resolution of the input image may be 1.5 mm, 2 mm, 3 mm, 4 mm, 5 mm, 6 mm, 7 mm and the like. The original input data 101, 103 may be voxel image (e.g., 3D voxel image of Height×Width×Depth). For example, the original input data with a 1.5 mm resolution corresponds to 1.5 mm cubic voxels in the original input data.

### Data and Pre-Processing

In some embodiments, the original input data 101, 103 may be pre-processed to be more suitable for being processed by the convolutional neural network (CNN). The pre-processing method can advantageously improve the efficiency of computation and accuracy of the prediction result. In some cases, the pre-processing of the input data may comprise arranging the original PET/CT image data (e.g., 3D voxel image of Height×Width×Depth) into multiple channels by dividing the original PET/CT image data based on intensity range. In some cases, the multiple channels (e.g., 5 channels) may correspond to different intensity ranges of the PET/CT image. For example, the original PET/CT image data may be of size 128×96×96 and is converted to multiple channels (e.g., 5 channels) in the size of 5×128×96×96 such that each channel is a 128×96×96 image corresponding to an intensity range.

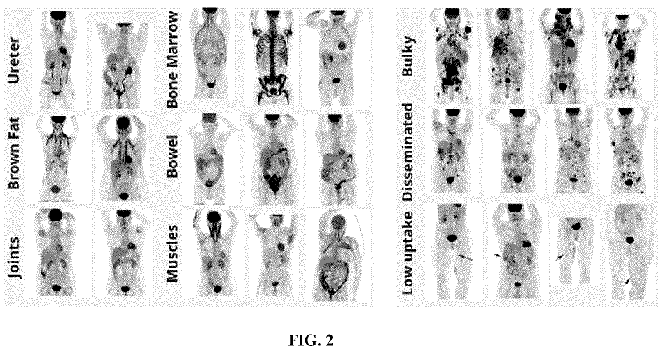

Converting the original image into multiple channels or multiple intensity ranges beneficially allows for the CNN to process the data similar to a radiologist (e.g., mimic the ranges a radiologist uses to discriminate the various FDG uptakes) as certain range of intensities correspond to different patterns. FIG. 2 shows examples of various FDG uptakes in different tissues across different patients. As shown in FIG. 2, FDG uptakes may appear differently in the PET and CT images across different types of cancers, tumors or tissues. For example, brown fat is presented as hot on the PET image and can be mistaken for a tumor but the brown fat is correctly presented with the “fat” intensity in CT. Thus, splitting the intensity range beneficially allows the CNN to disentangle the input information and provide more accurate segmentation.

In some embodiments, the number of channels/intensity ranges or the range value may be dependent on the subject/tissue being imaged, or the radiological or physical property of the tissue, historical data (e.g., patterns of FDG uptakes in different tissues) or radiologist experience and other parameters (e.g., types of tumors, etc.). In some cases, the intensity ranges for the data pre-processing may mimic the ranges a radiologist uses to discriminate the various FDG uptakes and help the neural network disentangle the inputs. In some cases, the original raw image data such as PET standardized uptake value (SUV) and CT volumes may be processed to be arranged into multiple channels or intensity ranges. SUV is a measure of the relative uptake in a region of interest. The standardized uptake value (SUV) is a dimensionless ratio defined as the ratio of activity per unit volume of a region of interest (ROI) to the activity per unit whole body volume. For diagnosis, SUV is useful for determining whether or not an area of uptake should be reported as suspicious for malignancy. However, for defining the edges of a radiation target, the use of SUV is limited and uncertain. The present disclosure may be capable of segmenting a lesion target accurately and consistently by converting the input image into multiple intensity ranges by taking into account the different SUV ranges across different tissues/tumors.

For example, an original PET SUV image may be mapped from (0, 30) SUV to (0, 1) range. This range may capture most of the PET intensities. The CT image (CT image that matched the PET) may be mapped from the original range of (−150, 300) to range of (0, 1). This range may capture the important patterns of the CT. In some cases, the CT image may be mapped to a CT soft range such as range (−100, 100) to focus on the soft-tissue intensities. In some cases, the intensity range may be dependent on the tissue or subject being imaged. For example, the original CT image may be mapped to a CT Lung range such as range of (−1000, −200) to capture the intensities of the lung tissues. In some cases, the PET SUV image may be mapped to a SUV hot range such as range of (2, 10) of the PET SUV to focus on the mid-range intensities of the lesions (in which the intensity corresponds to a number of counts). This range may be useful for lesions with low uptake.

In some cases, the number of channels and/or intensity ranges that the original raw image data to be converted into may be predetermined. A user may define or modify the intensity ranges for pre-processing the input data. The number of channels and/or intensity ranges may be set up by a user manually prior to or during the image processing. In some cases, pre-set rules may be generated and stored by the system for determining the intensity ranges or channels. For instance, the pre-set rules may specify the intensity ranges for a particular type of cancer, tissue, type of image, and the like. Alternatively or additionally, the system may automatically pre-process the input PET/CT data into multiple channels and intensity ranges based on the imaged subject and/or imaging parameters. For instance, the acquired PET/CT data may be converted to the multiple channels based on the tissue or parameters identified by the system in real-time. In some cases, a user may be permitted to modify the intensity ranges or number of channels that are suggested by the system. In some cases, the system may automatically adjust the intensity ranges or number of channels based on a user provided feedback.

The pre-processed input data 104 may be transformed to a predetermined resolution. For instance, the original PET, CT data having original resolution of 1.5 mm (1.5 mm per pixel) may be resampled at a resolution of 6 mm 105. The predetermined resolution may be any number such as 3 mm, 4 mm, 5 mm, 6 mm, 7 mm, 8 mm, 9 mm, 10 mm, etc. This may beneficially allow for the cascaded model to be resolution independent. The predetermined resolution may be lower than, equal to or higher than the original resolution.

### Model and Training

The image resampled at the predetermined resolution 105 may then be processed by a first module 110. The first module 110 may have a large field of view to analyze the image 105 at a coarse level global patterns and long-range dependencies. In some examples, the first module may comprise an ensemble of a plurality of UNet models (e.g., 4 UNet models) 111 that are linearly aggregated to output an intermediate segmentation mask 113. The intermediate segmentation mask 113 may have a resolution same as the predetermined resampled resolution 105. In some cases, the intermediate segmentation mask may have a resolution lower than the resolution of the original input image. For example, the intermediate segmentation mask may have a resolution same as the predetermined resampled resolution 105 if the re-sampled resolution is lower than the original resolution.

The first module 110 may comprise an ensemble of U-net-like neural networks. The U-net architecture is a multi-scale encoder-decoder architecture, with skip-connections that forward the output of each of the encoder layers directly to the input of the corresponding decoder layers. The plurality of U-net-like may be based on three-dimensional (3D) and 2.5D (stack of 2D images) convolutions. In some embodiments, the U-net may have a modified architecture that takes as input of channels X 3D volume. For example, the input processed by the U-net model may be 5×128×96×96 images (e.g., 5 channels with each channel is a 3D volume of 128×96×96). Each channel corresponds to an intensity range as described above. As an example, the channels of the U-net models may be set to [64, 96, 128, 156] with a stride of 2 for each layer. In addition to modifying the channels of the U-net models, the middle block of U-net models may be modified to include large kernels (e.g., 3D kernel of 9×9×9). Utilizing kernels of increase dimension beneficially encourages the detection of long-range dependencies. In some embodiments, the model may use Leaky ReLU as activation function and instance normalization as normalization layer.

In some embodiments, outputs (e.g., segmentation masks) from the plurality of UNet models (e.g., 4 UNet models) may be aggregated to generate an output (e.g., an intermediate segmentation mask) 113. In some embodiments, the ensemble of the plurality of U-net models may comprise linearly weighting the output of each model to form the output 113. The output 113 may be an intermediate segmentation mask. In some cases, the intermediate segmentation mask may have a resolution lower than the resolution of the original image data 101, 103). For example, the ensemble of four U-nets may process the resampled image data in the multiple channels 105 (e.g., predetermined resolution of 6 mm) and output an intermediate segmentation mask 113 (e.g., resolution of 6 mm intermediate segmentation mask).

The plurality of U-nets may be trained on different splits of development dataset. In some cases, the dataset for training the model may be divided in two independent sets including a development dataset and test dataset at the patient level to avoid data leakage. The development dataset may be further split into subsets for training the plurality of U-nets. For instance, the development database may be split in 15-fold cross-validation sets. The training method may comprise minimizing the variance among the plurality models trained on split of datasets. In the case when the distribution has long tail distributions of the lesions, all the splits may be stratified by overall lesion volume and number of lesions to minimize the model variance trained on the different dataset slits.

In some cases, data augmentation schemes may be employed to augment the training dataset. The present disclosure provides augmentation schemes with improvements on the validation splits. In some cases, the data augmentation schemes may comprise generating augmented data by random axis flip of the original image (e.g., PET, CT image) for all three dimensions, random affine transformation which included random rotations and isotropic scaling (for PET, CT image), and random Gaussian blur, brightness, contrast and gamma transformations (for PET image) or any combination of the above. In some cases, the training dataset for training the refiner network may employ an additional transformation that resampled the data using random spacing to make the refiner network independent from the resolution of the original input image.

The training process may employ deep supervision to train the modified U-nets. The deep supervision method may stabilize the training. For instance, the training method may use a loss function based on a combination of cross-entropy loss and dice loss which beneficially stabilizes the training. Details about the loss function are described later herein.

The second module may take as input the at least part of the original input image and the intermediate segmentation mask to generate a final segmentation result. As shown in FIG. 1, the refiner network 120 of the second module may take as input images 115 at original resolutions (e.g., 1.5 mm, 2 mm, 3 mm, etc.) along with the intermediate segmentation mask 113 with the predetermined resolution (e.g., 6 mm segmentation mask) and output a final segmentation mask 121 that matches the original image resolution. The input image 115 may comprise at least a portion of the original image. For example, the input image 115 may have a resolution same as the original image but may or may not be the full size of the original image. For instance, the input image 115 may be a cropped region (e.g., 5×64×64×64) of the original image (e.g., 5×128×96×96). The input image 115 may have the same channels as the pre-processed input image 104.

In some embodiments, the refiner network 120 may have a model architecture comprising a stem block with 3D kernels (e.g., 9×9×9 kernel) followed by residual blocks (e.g., 4×(33 convolution, leaky ReLU, instance norm) residual blocks) with a final convolution layer (e.g., 33 convolution) to calculate the final segmentation mask 121.

In some embodiments, the models (e.g., each U-net model, the ensemble stack of the U-nets, refiner network) may be trained to minimize a loss function. The loss function may be based on metrics including dice similarity coefficient (dice coefficient is an overlap metric used for assessing the quality of segmentation mask) and cross-entropy (a measure of the difference between two probability distributions for a given random variable or set of events) for stabilizing the training. In some cases, the metrics also include sensitivity (sensitivity describes the probability of a positive sample being classified as positive). An example of the loss function is the following:

$$loss = dice loss + 0.5 * cross - entropy loss + 2 * sensitivity loss$$

The loss function may be a weighted combination of dice loss, cross-entropy loss and sensitivity loss. Combining dice loss with cross-entropy loss may beneficially allow for a more stable training of the models. The sensitivity loss beneficially encourages the models to segment smaller lesions at the cost of additional false positives.

In some embodiments, each model (e.g., U-Net 111, ensemble stacking of the U-nets 110, refiner network 120) may be trained separately. In some cases, the training algorithm may involve an improved Adam algorithm such as AdamW optmizer (AdamW optimizer decouples the weight decay from the optimization step such that weight decay and learning rate can be optimized separately, i.e. changing the learning rate does not change the optimal weight decay). As an example, the training algorithm may use the AdamW optimizer with a learning rate of 1e-3, weight decay of 1e-6 and a decayed cosine warm restart scheduler (T=200 epochs, decay=0.9 for each period). Gradient clipping may be applied to stabilize the training.

### Post-Processing

In optional embodiments, sequence-based models such as Recurrent Neural Networks (RNN), Long Short-Term Memory (LSTM) and/or Gated Recurrent Units (GRU) may be utilized in the post-processing of the output to reduce the false positive segmentations. For instance, the final segmentation map 121 outputted by the refiner network 120 may be relabeled using connected components. All features of the penultimate layer (fully connected hidden layer) of the segmentation model belonging to the same connected components may be averaged. In some embodiments of the post-processing methods, high-order features may also be added (e.g., tumor volumes, SUV max, SUV std, position in volume, shape descriptors, etc.). Finally, a sequence model may be used to re-classify the connected components. Leveraging the segmentation as sequences beneficially allows for modeling long range dependencies and high order features that may mimic features important to a radiologist.

### Experiment and Results

Experiment shows that the proposed algorithm accurately segmented wholebody ¹⁸F-FDG PET/CT images.

Images are acquired for patient cohort consisting of patients with histologically proven malignant melanoma, lymphoma or lung cancer who were examined by FDG-PET/CT in two large medical centers. Two expert radiologists with 5 and 10 years of experience annotated the dataset using manual free-hand segmentation of identified lesions in axial slices. In total, 900 patients were acquired in 1014 different studies. 50% of the patients were negative control patients. As shown in FIG, 2, a wide range of normal FDG uptakes were present such as brown fat, bone marrow, bowel, muscles, ureter and joints as well as within class variations. Similarly, patients with lesions showed large variations such as bulky, disseminated or low uptake patterns. FIG. 2 shows patients illustrating the large variations in appearance of normal uptake patterns (left panel) and within class variations, and FDG uptake variations of cancerous lesions (right panel).

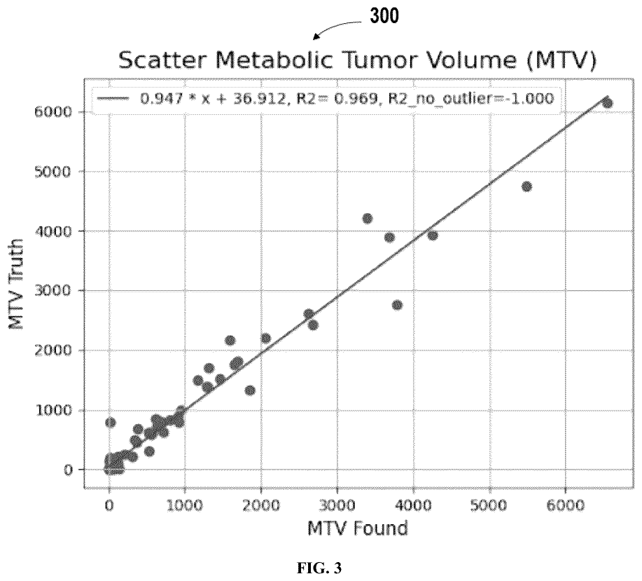

In an experiment, 930 cases were used for the training of the models and 84 cases were held out for the final evaluation. Qualitatively, the model produced accurate segmentations. The method considers the typical variations in appearance of normal uptakes such as hot organs (e.g., kidneys, bladder, brain, heart, ureter), brown fat, bone marrow, inflammation (e.g., bowel joints), muscles. FIG. 3 shows the result that segmentations of lesions was accurate, all large lesions were segmented. Scatter plot of the manually and automatically segmented metabolic tumor volumes on the test data in FIG. 3 shows that the segmentation of metabolically tumor volumes has equivalent result of manually segmented metabolically tumor volumes.

| Config | Dice | Dice Foreground | FN | FP | Sensitivity | MTV found | MTV | time (s) |
|---|---|---|---|---|---|---|---|---|
| M0 | 0.4819 | 0.6643 | 15.39 | 15.53 | 0.7426 | 558.6 | 485.4 | 4.94 |
| M1 | 0.4776 | 0.6583 | 21.63 | 15.52 | 0.7097 | 530.6 | 485.4 | 4.25 |
| M2 | 0.4709 | 0.6618 | 22.07 | 26.30 | 0.6939 | 525.0 | 485.4 | 4.06 |
| M3 | 0.5028 | 0.6658 | 26.33 | 12.51 | 0.7072 | 544.5 | 485.4 | 4.09 |
| Ensemble | 0.5049 | 0.6823 | 19.59 | 11.59 | 0.7255 | 536.3 | 485.4 | 8.91 |
| Full | 0.4942 | 0.6813 | 16.46 | 17.85 | 0.6446 | 413.2 | 485.4 | 89.7 |

Above table shows results of the models on the held-out test split. ‘Dice Foreground” represents the dice of the cases that have a segmentation. ‘Dice’ represent the dice results on all the cases. ‘FN’ represents the false negative volumes, ‘FP’ represents the false positive volume, ‘MTV’ represents the average volume of the segmentations expressed in voxels.

The above table shows that resulting dice were very similar for the models (e.g., four U-net models M0, M1, M2, M4) trained on different splits. The ensemble network had an improved ‘dice’ and ‘dice foreground’. The refiner network was able to keep very similar performance characteristics while operating on the full-scale image with FP and FN volumes adequately rebalanced.

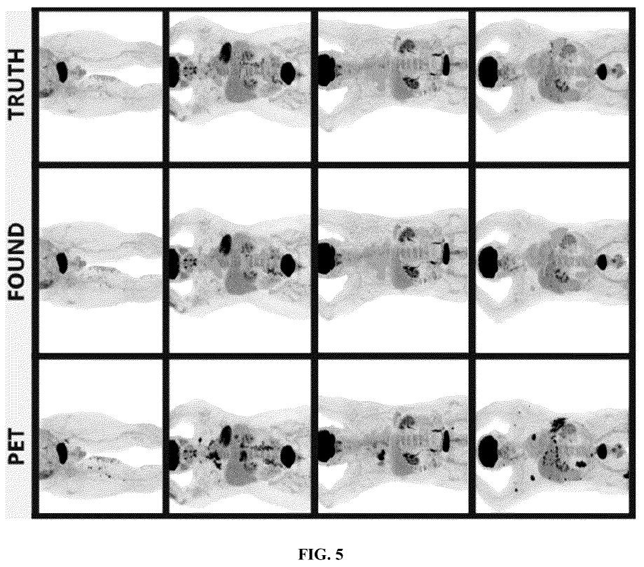

FIG. 5 shows example of the segmentation of lesion generated by the system herein (FOUND) compared to the ground truth result (TRUTH).

### System Overview

The systems and methods can be implemented on existing imaging systems such as but not limited to positron emission tomography (PET) imaging system, CT imaging system or PET/CT imaging systems without a need of a change of hardware infrastructure.

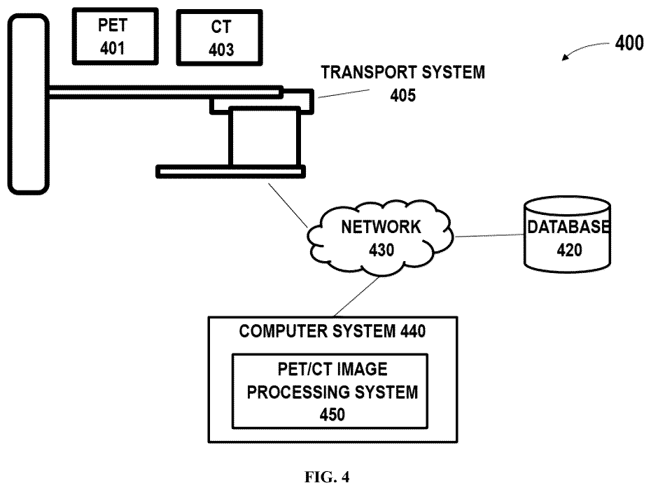

FIG. 4 shows an example of the system 400 implementing the methods described herein. A PET-CT imaging system combines multiple rings of detectors for the PET and computed tomography (CT) into one imaging system. The PET and CT images are processed and combined to generate an original input data. In some embodiments, the PET/CT imaging system may comprise a controller for controlling the operation, imaging of the two modalities (PET imaging module 401, CT imaging module 403) or movement of transport system 405. For example, the controller may control a CT scan based on one or more acquisition parameters set up for the CT scan and control the PET scan based on one or more acquisition parameters set up for the PET scan. The controller may apply a tomographic reconstruction algorithm (e.g., filter backprojection (FBP), iterative algorithm such as algebraic reconstruction technique (ART), etc.) to the multiple projections, yielding a 3-D data set. The PET image may be combined with the CT image to generate the combined image as output of the imaging system. in some cases, the PET image may be 2.5D where 2D images are reconstructed on each of the planes, and are stacked to form a 3D image volume. In some cases, the PET image may be fully 3D where coincidences are also recorded along the oblique planes.

The controller may be coupled to an operator console (not shown) which can include input devices (e.g., keyboard) and control panel and a display. For example, the controller may have input/output ports connected to a display, keyboard and or other IO devices. In some cases, the operator console may communicate through the network with a computer system that enables an operator to control the production and display of images on a screen of display. In some cases, images may be segmented in real-time and displayed on the screen

The system 400 may comprise a user interface. The user interface may be configured to receive user input and output information to a user. The user input may be related to controlling or setting up an image acquisition scheme. For example, the user input may indicate scan duration (e.g., the min/bed) for each acquisition or scan time for a frame that determines one or more acquisition parameters for an accelerated acquisition scheme. The user input may be related to the operation of the PET/CT system (e.g., certain threshold settings for controlling program execution, image reconstruction algorithms, etc) or for modifying the segmentation related parameters (e.g., channels of input data or intensity ranges). The user interface may include a screen such as a touch screen and any other user interactive external device such as handheld controller, mouse, joystick, keyboard, trackball, touchpad, button, verbal commands, gesture-recognition, attitude sensor, thermal sensor, touch-capacitive sensors, foot switch, or any other device.

The system 400 may comprise computer systems and database systems 420, which may interact with a PET/CT imaging processing system 450. The computer system may comprise a laptop computer, a desktop computer, a central server, distributed computing system, etc. The processor may be a hardware processor such as a central processing unit (CPU), a graphic processing unit (GPU), a general-purpose processing unit, which can be a single core or multi core processor, or a plurality of processors for parallel processing. The processor can be any suitable integrated circuits, such as computing platforms or microprocessors, logic devices and the like. Although the disclosure is described with reference to a processor, other types of integrated circuits and logic devices are also applicable. The processors or machines may not be limited by the data operation capabilities. The processors or machines may perform 512 bit, 256 bit, 128 bit, 64 bit, 32 bit, or 16 bit data operations. The imaging platform may comprise one or more databases. The one or more databases may utilize any suitable database techniques. For instance, structured query language (SQL) or “NoSQL” database may be utilized for storing image data, raw collected data, reconstructed image data, training datasets, trained model (e.g., hyper parameters), loss function, weighting coefficients, etc. Some of the databases may be implemented using various standard data-structures, such as an array, hash, (linked) list, struct, structured text file (e.g., XML), table, JSON, NOSQL and/or the like. Such data-structures may be stored in memory and/or in (structured) files. In another alternative, an object-oriented database may be used. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the database of the present disclosure is implemented as a data-structure, the use of the database of the present disclosure may be integrated into another component such as the component of the present disclosure. Also, the database may be implemented as a mix of data structures, objects, and relational structures. Databases may be consolidated and/or distributed in variations through standard data processing techniques. Portions of databases, e.g., tables, may be exported and/or imported and thus decentralized and/or integrated.

The network 430 may establish connections among the components in the imaging platform and a connection of the imaging system to external systems. The network may comprise any combination of local area and/or wide area networks using both wireless and/or wired communication systems. For example, the network may include the Internet, as well as mobile telephone networks. In one embodiment, the network uses standard communications technologies and/or protocols. Hence, the network may include links using technologies such as Ethernet, 802.11, worldwide interoperability for microwave access (WiMAX), 2G/3G/4G/5G mobile communications protocols, asynchronous transfer mode (ATM), InfiniBand, PCI Express Advanced Switching, etc. Other networking protocols used on the network can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), and the like. The data exchanged over the network can be represented using technologies and/or formats including image data in binary form (e.g., Portable Networks Graphics (PNG)), the hypertext markup language (HTML), the extensible markup language (XML), etc. In addition, all or some of links can be encrypted using conventional encryption technologies such as secure sockets layers (SSL), transport layer security (TLS), Internet Protocol security (IPsec), etc. In another embodiment, the entities on the network can use custom and/or dedicated data communications technologies instead of, or in addition to, the ones described above.

In some embodiments, the PET/CT imaging processing system 450 may comprise multiple components, including but not limited to, a training module, an image segmentation module, and a user interface module.

The training module may be configured to train a model using the deep learning model framework as described above. The training module may pre-process the image data, augment training data, split data into multiple sets for training the multiple U-nets and perform various training methods and algorithms as described elsewhere herein. The training module may train a model off-line. Alternatively or additionally, the training module may use real-time data as feedback to refine the model for improvement or continual training.

The image segmentation module may be configured to segment the PET/CT image data using a cascaded model framework obtained from the training module. For example, the image segmentation module may comprise a first module including the ensemble of U-nets and a refiner network. The image segmentation module may also comprise a component for transforming the original input image into multiple channels and resampled to a predetermined resolution as described elsewhere herein.

The user interface (UI) module may be configured to provide a UI to receive user input related to the segmentation. For instance, a user may be permitted to, via the UI, set the number of channels, intensity ranges, feedback for the segmentation, etc.

Methods and systems of the present disclosure can be implemented by way of one or more algorithms. An algorithm can be implemented by way of software upon execution by the central processing unit.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A computer-implemented method for segmentation of Positron emission tomography (PET)/computed tomography (CT), the method comprising:
(a) acquiring an original medical image including a PET image and CT image of a subject;
(b) transforming the original medical image into an input image with a predetermined resolution and a plurality of channels, wherein the plurality of channels correspond to a plurality of intensity ranges;
(c) processing the input image using an ensembled convolutional neural networks (CNNs) to output an intermediate segmentation mask; and
(d) taking the intermediate segmentation mask as input to a refiner model to output a final segmentation mask, wherein the final segmentation mask has a resolution same as the resolution of the original medical image.

2. The computer-implemented method of claim 1, wherein the predetermined resolution is lower than the resolution of the original medical image.

3. The computer-implemented method of claim 1, wherein the intermediate segmentation mask has a resolution same as the predetermine resolution.

4. The computer-implemented method of claim 1, wherein the plurality of channels are determined automatically by processing the original medical image.

5. The computer-implemented method of claim 1, wherein the plurality of channels are determined manually by a user.

6. The computer-implemented method of claim 1, wherein the ensembled CNNs comprise a plurality of 3D U-net like CNNs.

7. The computer-implemented method of claim 6, wherein a plurality of outputs of the 3D U-net like CNNs are linearly weighted to generate the intermediate segmentation mask.

8. The computer-implemented method of claim 1, wherein the input to the refiner model further comprises at least a portion of the original medial image.

9. The computer-implemented method of claim 1, wherein the ensembled CNNs and the refiner model are trained separately using a loss function.

10. The computer-implemented method of claim 9, wherein the loss function comprises a combination of dice loss and a cross-entropy loss to stabilize the training.

11. The computer-implemented method of claim 10, wherein the loss function further comprises a sensitivity loss.

12. A non-transitory computer-readable storage medium including instructions that, when executed by one or more processors, cause the one or more processors to perform operations comprising:
(a) acquiring an original medical image including a PET image and CT image of a subject;
(b) transforming the original medical image into an input image with a predetermined resolution and a plurality of channels, wherein the plurality of channels correspond to a plurality of intensity ranges;
(c) processing the input image using an ensembled convolutional neural networks (CNNs) to output an intermediate segmentation mask; and
(d) taking the intermediate segmentation mask as input to a refiner model to output a final segmentation mask, wherein the final segmentation mask has a resolution same as the resolution of the original medical image.

13. The non-transitory computer-readable storage medium of claim 12, wherein the predetermined resolution is lower than the resolution of the original medical image.

14. The non-transitory computer-readable storage medium of claim 12, wherein the intermediate segmentation mask has a resolution same as the predetermine resolution.

15. The non-transitory computer-readable storage medium of claim 12, wherein the plurality of channels are determined automatically by processing the original medical image.

16. The non-transitory computer-readable storage medium of claim 12, wherein the plurality of channels are determined manually by a user.

17. The non-transitory computer-readable storage medium of claim 12, wherein the ensembled CNNs comprise a plurality of 3D U-net like CNNs.

18. The non-transitory computer-readable storage medium of claim 17, wherein a plurality of outputs of the 3D U-net like CNNs are linearly weighted to generate the intermediate segmentation mask.

19. The non-transitory computer-readable storage medium of claim 12, wherein the input to the refiner model further comprises at least a portion of the original medial image.

20. The non-transitory computer-readable storage medium of claim 12, wherein the ensembled CNNs and the refiner model are trained separately using a loss function.
